(19) United States
(12) Patent Application Publication
(10) Pub. No.: US 2004/0110087 A1
(43) Pub. Date: Jun. 10, 2004

(54) Optical information recording medium

(75) Inventors: Takako Ozawa, Kanagawa (JP); Takeshi Kakuta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/644,897

(22) Filed: Aug. 21, 2003

(30) Foreign Application Priority Data
Aug. 22, 2002 (JP) 2002-241581

(51) Int. Cl. G11B 7/24

(52) U.S. Cl. 430/270.13; 430/270.15; 430/945; 369/288; 428/64.8

(57) ABSTRACT

The present invention provides an optical information recording medium including a substrate having successively disposed thereon a light-reflective layer, a recording layer and a cover layer, wherein information can be recorded on and reproduced from the recording layer by irradiating a laser beam from a side at which the cover layer is disposed, and a surface of the light-reflective layer at a side at which the recording layer is disposed has a central surface average roughness SRa of 30 nm or smaller and a number of projections having a height from a reference plane of 50 nm or greater, as determined with an atomic force microscope (AFM), of 30 (number/90 μm angle) or less.

### CROSS-REFERENCE TO RELATED APPLICATION

This application claims priority under 35 USC 119 from Japanese Patent Application No. 2002-241581.

### BACKGROUND OF THE INVENTION

1. Field of the Invention

The present invention relates to an optical information recording medium, and more specifically to an optical information recording medium that is writable only once by heat mode.

2. Description of Related Art

With increases in information processing throughput, there is also a strong demand for improvement in recording capacity in the field of optical information recording. A recording pit has been conventionally formed using a light beam having a recording wavelength of 635 nm. However, even higher density is demanded since the start of HDTV (High Definition Television) BS digital broadcasting is near at hand. In particular, an optical disk system that uses a blue-violet laser having a wavelength shorter than 635 nm and a high NA pick-up has been developed and researched, and in ISOM 2000 a DVR-Blue, which uses a blue-violet laser in a phase transition medium, has been developed (Japanese Patent Application Laid-Open (JP-A) No. 10-302243). However, there are problems in that when extremely small recording pits are formed using a light beam having a short wavelength, the size and shape of the recording pits formed are irregular, resulting in lowered performance with respect to jitter, error rate and the like.

Further, since the DVR-Blue utilizes high NA recording, a distance from a cover layer to a reflective layer is small, whereby if the surface of a reflective layer is rough or if the proportion of relatively high projections in an entire area is high, readability of recording marks is affected, resulting in lowered performance with respect to jitter, error rate and the like.

The light-reflective layer is usually formed by sputtering a metal such as Ag or Al. However, in the case where the surface of the formed light-reflective layer has poor smoothness and hence the reflectance is not uniform, readability of recording marks is adversely affected, leading to lowered performance with respect to jitter, error rate and the like. Accordingly, it is desirable that the surface of the light-reflective layer be smooth and the reflectance of the entire surface be uniform so as to decrease noise and improve performance with respect to jitter, error rate and the like.

### SUMMARY OF THE INVENTION

The present invention was accomplished in view of the above-described circumstances and an object thereof is to achieve the following.

Namely, an object of the invention is to provide an optical information recording medium having low noise, superior jitter characteristics and high reliability.

The invention provides an optical information recording medium which comprises a substrate having successively disposed thereon a light-reflective layer, a recording layer and a cover layer, wherein information can be recorded on and reproduced from the recording layer by irradiating a laser beam from a side at which the cover layer is disposed, and a surface of the light-reflective layer at a side at which the recording layer is disposed has a central surface average roughness SRa of 30 nm or smaller and a number of projections having a height from a reference plane of 50 nm or greater, as determined with an atomic force microscope (AFM), of 30 (number/90 μm angle) or less.

### DETAILED DESCRIPTION OF THE INVENTION

An optical information recording medium according to the present invention comprises a substrate having a light-reflective layer, a recording layer and a cover layer disposed in this sequence, wherein information can be recorded on and reproduced from the recording layer by irradiating a laser beam from a side at which the cover layer is disposed, and a surface of the light-reflective layer at a side at which the recording layer is disposed has a central surface average roughness SRa of 30 nm or smaller and a number of projections having a height from a reference plane of 50 nm or greater, as determined with an atomic force microscope (AFM), of 30 (number/90 μm angle) or less.

The optical information recording medium of the invention will now be explained in more detail.

Substrate

Materials conventionally used for optical information recording media substrate can be arbitrarily selected and used as the material for the substrate of the invention.

Specific examples of such substrate materials include glass, polycarbonate, acrylic resins such as polymethyl methacrylate, vinyl chloride-type resins such as polyvinyl chloride and copolymers of vinyl chloride, epoxy resins, amorphous polyolefins, polyesters and metals such as aluminum. If necessary, these materials may be used in combination.

Among the materials listed above, amorphous polyolefins and polycarbonate are more preferable from the standpoints of moisture resistance, dimension stability and low cost. Polycarbonate is particularly preferable. The thickness of the substrate is preferably 1.1 ±0.3 mm.

A guide groove for tracking or a pre-groove representing information such as address signals is formed on the substrate. In order to achieve higher storage density, it is preferable to use a substrate having a pre-groove with a track pitch that is narrower than the track pitch in a conventional CD-R or DVD-R. It is essential that the track pitch of the pre-groove is 200 to 400 nm, and preferably 280 to 340 nm. It is also essential that the depth of the pre-groove (groove depth) is 20 to 150 nm, and preferably 30 to 80 nm.

An undercoat layer is preferably disposed on the surface of the substrate at the side disposed with the light-reflective layer, in order to improve surface smoothness and enhance adhesion.

Examples of materials for the undercoat layer include polymeric substances such as polymethyl methacrylate, acrylic acid/methacrylic acid copolymers, styrene/maleic anhydride copolymers, polyvinyl alcohol, N-methylolacrylamide, styrene/vinyltoluene copolymers, chlorosulfonated polyethylene, nitrocellulose, polyvinyl chloride, chlorinated polyolefin, polyester, polyimide, vinyl acetate/vinyl chloride copolymers, ethylene/vinyl acetate copolymers, polyethylene, polypropylene, polycarbonate and the like; and surface-modifying agents such as silane coupling agents.

The undercoat layer may be formed by preparing a coating liquid by dissolving or dispersing the above-mentioned material in a suitable solvent, and applying the coating liquid to the substrate surface by spin coating, dip coating, extrusion coating, or the like. The thickness of the undercoat layer is normally 0.005 to 20 μm, and preferably 0.01 to 10 μm.

Light-Reflective Layer

In the invention, any material having a reflectance over 70% with respect to lasers may be used for the light-reflective layer.

Examples of the light-reflective material having the reflectance over 70% with respect to lasers include metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi, and stainless steel. These light-reflective materials may be used singly or in combination of two or more, or alternatively as alloys. Among these materials, Au, Ag, and their alloys are preferable. Au, Ag, and the alloys containing Au and Ag as the main component are particularly preferable.

The light-reflective layer may be formed by, for example, vacuum-depositing, sputtering or ion-plating the aforementioned light-reflective material on the substrate. Among the above, sputtering is preferably employed.

In the optical information recording medium of the invention, the surface of the light-reflective layer at a side at which the recording layer, to be described later, is disposed is characterized in that the central surface average roughness SRa is 30 nm or less and the number of projections having a height from a reference plane which is measured using an atomic force microscope (AFM) (hereinafter referred to simply as “reference plane”) of 50 nm or greater is 30 (number/90 μm angle) or less. The reference plane as used herein refers to a plane at which an average of heights in the direction Z when determined using an atomic force microscope (AFM) is Z0. In other words, the reference plane is a plane expressed by Z=Z0 and parallel to the XY plane.

When the central surface average roughness SRa exceeds 30 nm, specifically, if the surface of the light-reflective layer is rough, reflected light is likely scattered, thereby causing increased noise and deteriorated jitter and error rate. The central surface average roughness SRa is preferably in a range of from 0.25 to 10 nm, and more preferably from 0.25 to 2.5 nm. Incidentally, it is impossible to make the central surface average roughness SRa be 0 from the standpoint of a manufacturing limitation.

If the number of projections having a height from a reference plane on the surface of the light-reflective layer of 50 nm or greater exceeds 30 (number/90 μm angle), reflected light is likely scattered, thus causing increased noise and impaired jitter and error rate. Although a very specific case, there arises a case of producing coating unevenness, recording void, increased noise and impaired jitter and error rate. The number of projections is preferably 15 (number/90 μm angle) or less, and more preferably 5 (number/90 μm angle) or less. The lower limit of the number of projections is ideally 0 (number/90 μm angle).

If the central surface average roughness SRa and the number of projections on the surface of the light-reflective layer are within the above range, increased noise and deteriorated jitter may be prevented.

It is noted that the central surface average roughness SRa is a value calculated after the cover layer is peeled off, the recording layer is removed using an alcohol-type solvent and a smooth area of the surface is measured using an atomic force microscope (AFM) (30 μm×30 μm angle).

The above number of projections is a number of projections having a height from a reference plane of 50 nm or greater detected after the cover layer is peeled off, the recording layer is removed using an alcohol-type solvent and a smooth area of the surface is subjected to a three view-field measurement using an atomic force microscope (AFM) (30 μm×30 μm angle).

The conditions where the central surface average roughness SRa and the number of projections on the surface of the light-reflective layer can be regulated to the above specific ranges may be attained by making each parameter shown in the following (1) to (3) fall within the value ranges given below. The following is an example of forming the light-reflective layer by a sputtering method.

(1) Thickness of Light-Reflective Layer

When a thickness of the light-reflective layer is excessively small, a decrease in the reflectance may occur. On the other hand, when the thickness is excessively large, segregation may occur to render the surface of the light-reflective layer rougher. Therefore, the thickness of the light-reflective layer is specified in a range of 10 to 250 nm, and preferably 60 to 150 nm. The thickness of the light-reflective layer may be controlled by a sputtering time. The sputtering time is preferably 2 to 10 seconds.

(2) Sputtering Power

When a sputtering power is excessively large, segregation partly occurs, making the surface rougher. Therefore, the sputtering power when forming the light-reflective layer is specified in a range of 0.1 to 5 kW, and preferably 0.2 to 3 kW.

(3) Argon Flow Rate

When an argon flow rate for sputtering the light-reflective material is excessively high, the surface of the light-reflective layer become rougher because the partly occurred segregation are likely to grow, and also the segregation tends to be progressed at projecting points to make protrusions easily generate. Therefore, the argon flow rate for sputtering when forming the light-reflective layer is specified in a range of 0.1 to 30 cm³/sec, and preferably 0.2 to 3 cm³/sec.

Recording Layer

The recording layer is formed on the light-reflective layer. The recording material may be either a phase change metal (alloy) or an organic compound. Examples of the phase change metal include a Sb—Te alloy, Ge—Sb—Te alloy, Pd—Ge—Sb—Te alloy, Nb—Ge—Sb—Te alloy, Pd—Nb—Ge—Sb—Te alloy, Pt—Ge—Sb—Te alloy, Co—Ge—Sb—Te alloy, In—Sb—Te alloy, Ag—In—Sb—Te alloy, Ag—V—In—Sb—Te alloy and Ag—Ge—In—Sb—Te alloy. Among these alloys, a Ge—Sb—Te alloy and an Ag—In—Sb—Te alloy are preferable because these alloys are rewritable plural times. The phase change metal may be formed on the light-reflective layer by a vapor phase film depositing method such as vacuum deposition method, sputtering method or the like.

As the organic compound (dye) contained in the recording layer, the dyes described in JP-A Nos. 4-74690, 8-127174, 11-53758, 11-334204, 11-334205, 11-334206, 11-334207, 2000-43423, 2000-108513 and 2000-158818, and additionally, triazole, triazine, cyanine, merocyanine, aminobutadiene, phthalocyanine, cinnamic acid, viologen, azo, oxonol, benzoxazole, benztriazole and the like are preferable, with cyanine, aminobutadiene, benztriazole and phthalocyanine being more preferable.

The recording layer is formed by preparing a coating liquid by dissolving a recording material such as a dye together with a binder and the like in a suitable solvent, and applying the coating liquid to the light-reflective layer formed on the substrate surface to form a layer, followed by drying the layer. The concentration of the recording material in the coating liquid is normally 0.01 to 15% by mass, preferably 0.1 to 10% by mass, more preferably 0.5 to 5% by mass, and most preferably 0.5 to 3% by mass.

Examples of the solvent for preparing the dye coating liquid include esters such as butyl acetate, ethyl lactate and cellosolve acetate; ketones such as methyl ethyl ketone, cyclohexanone and methyl isobutyl ketone; chlorinated hydrocarbons such as dichloroethane, 1,2-dichloroethane and chloroform; amides such as dimethylformamide; hydrocarbons such as methylcyclohexane; ethers such as tetrahydrofuran, ethyl ether and dioxane; alcohols such as ethanol, n-propanol, isopropanol and n-butanol diacetone alcohol; fluorine-based solvents such as 2,2,3,3-tetrafluoropropanol; glycol ethers such as ethylene glycol monomethyl ether, ethylene glycol monoethyl ether and propylene glycol monomethyl ether.

These solvents may be used singly or in combination of two or more kinds thereof by taking into consideration of the solubility of the recording material used. The dye coating liquid may also contain additives such as an antioxidant, a UV absorbent, a plasticizer and a lubricant depending on the use purposes.

If a binder is used, examples of the binder include naturally occurring organic polymeric substances such as gelatin, cellulose derivatives, dextran, rosin, and rubber; and synthetic organic polymers, for example, hydrocarbon-based resins such as polyethylene, polypropylene, polystyrene and polyisobutylene; vinyl-type resins such as polyvinyl chloride, polyvinylidene chloride and vinyl chloride/vinyl acetate copolymers; acrylic resins such as polymethyl acrylate and polymethyl methacrylate; polyvinyl alcohol, chlorinated polyethylene, epoxy resins, butyral resins, rubber derivatives, and pre-condensates of heat-curable resins, e.g., phenol/formaldehyde resins. If the binder is used together with the recording material in the recording layer, the amount of the binder is generally 0.01 to 50 times (by mass ratio), and preferably 0.1 to 5 times (by mass ratio), relative to the recording material. The concentration of the recording material in the coating liquid thus prepared is generally 0.01 to 10% by mass, and preferably 0.1 to 5% by mass.

The dye solution may be coated by spraying, spin coating, dip coating, roll coating, blade coating, doctor roll coating, or screen printing.

The recording layer may comprise a single layer or several layers. The thickness of the recording layer is usually 20 to 500 nm, preferably 30 to 300 nm, and more preferably 50 to 100 nm.

In order to raise the lightfastness of the recording layer, various kinds of anti-fading agents may be incorporated in the recording layer.

Generally, a singlet oxygen quencher is used as the anti-fading agent. Singlet oxygen quenchers already described in publications such as patent specifications may be used.

Specific examples of the singlet oxygen quencher include those described in JP-A Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995 and 4-25492, Japanese Patent Application Publication (JP-B) Nos. 1-38680 and 6-26028, German Patent No. 350399, and the Journal of the Chemical Society of Japan, October 1992, p.1141.

The amount of the anti-fading agent such as the singlet oxygen quencher is usually in a range of 0.1 to 50% by mass, preferably in a range of 0.5 to 45% by mass, more preferably in a range of 3 to 40% by mass, and particularly preferably in a range of 5 to 25% by mass, relative to the amount of the dye used.

Bonding Layer

The bonding layer is formed in order to enhance adhesion between the recording layer and a cover sheet described later. As the adhesive for forming the bonding layer, a UV-curable resin or a pressure-sensitive adhesive is preferable. The UV-curable resins for use as the adhesive in the invention include conventionally known UV-curable resins. The pressure-sensitive adhesive for use as the adhesive in the invention refers to an adhesive capable of instantaneous adhesion with a very slight pressure, as normally applied on the rear surface of an adhesive double coated tape, label and the like. The thickness of the bonding layer is preferably 1 to 1,000 μm, more preferably 5 to 500 μm, and particularly preferably 10 to 100 μm in order to impart elasticity to the bonding layer.

The UV-curable resin for constituting the bonding layer may be a generally used UV-curable resin. In order to prevent warping of the disk, the UV-curable resins having a smaller coefficient of contraction are preferable. As the UV-curable resin, for example, SD-640 manufactured by Dainippon Ink & Chemicals, Inc. may be used. SD-347, SD-694 (both manufactured by Dainippon Ink & Chemicals, Inc.) and SKCD1051 (manufactured by SKC Co., Ltd.) may also be used.

When the pressure-sensitive adhesive is used as the adhesive, the pressure-sensitive adhesive in the form of a tape is adjusted to have a suitable size, affixed to the recording layer, followed by peeling off a separator and subsequent formation of the cover sheet.

If an adhesive double coated tape is used as the pressure-sensitive adhesive, any substrate may be used without any restriction for the adhesive double coated tape. Examples of the substrate include plastic films such as polyethylene terephthalate, polypropylene, polyethylene and vinyl chloride, papers such as craft paper, high quality paper, precoat paper and Japanese paper, non-woven fabrics such as rayon and polyester, woven fabrics made of synthetic fibers such as polyester, nylon and acryl, foils of metals such as aluminum, copper and stainless steel. Plastic films are preferable from the standpoint of uniformly coating a releasing agent in a striped pattern on the substrate.

Conventionally used releasing agents such as a silicone-based releaser and a long chain alkyl-based releaser may arbitrarily be selected and used as the releasing agent for the adhesive double coated tape.

Any adhesive that contributes adhesion may be used without any restriction. Acrylic pressure-sensitive adhesives as well as rubber-based pressure-sensitive adhesives such as natural rubber, styrene-isoprene-styrene copolymer (SIS) and styrene-butadiene-styrene copolymer (SBS) may suitably be selected and used in the invention.

Cover Layer

The cover layer (cover sheet) is formed in the invention to prevent water from penetrating into the interior of the optical information recording medium, and preferably made of a material having a transmittance of 80% or more for a laser beam for recording and reproducing (playback) information. Specifically, polycarbonate (Pure Ace manufactured by Teijin Ltd., Pan Light manufactured by Teijin Chemicals Ltd.), cellulose triacetate (Fuji Tack manufactured by Fuji Photo Film Co., Ltd.) and PET (Lumilar manufactured by Toray Corp.) are preferable, among which polycarbonate and cellulose triacetate are more preferable.

The cover layer is formed by preparing a coating liquid by dissolving a photo-curable resin for forming the bonding layer in a suitable solvent, applying the coating liquid to the recording layer at a predetermined temperature to form a coating layer, laminating thereon a cellulose triacetate film (TAC film) obtained by, e.g., extrusion of plastic to the coating layer, followed by irradiating the resulting laminate with light from the laminated TAC film side to thereby cure the coating layer. The above-mentioned TAC film preferably contains a UV absorbent. The thickness of the cover layer in the invention is 0.01 to 0.5 mm, preferably 0.05 to 0.2 mm, and more preferably 0.08 to 0.13 mm.

In order to control viscosity, the temperature at which coating is conduced is preferably 23 to 50° C., more preferably 24 to 40° C., and most preferably 25 to 37° C.

In order to prevent the disk from warping, it is preferable that a pulse-type light irradiator (preferably a UV irradiator) is used to irradiate the coating layer with ultraviolet light. The pulse interval is preferably msec or less, and more preferably μsec or less. Although the amount of light irradiated per pulse is not particularly limited, it is preferably 3 kW/cm² or less, and more preferably 2 kW/cm² or less.

Although the number of irradiation times is not particularly limited, it is preferably 20 or less, and more preferably 10 or less.

When the UV-curable resin is used as the adhesive, the UV-curable resin is applied as it is or after dissolved in an appropriate solvent such as methyl ethyl ketone or ethyl acetate to prepare a coating liquid, and the liquid is applied onto the recording layer and then irradiated with UV light to cure the UV-curable resin, whereby the cover layer may be formed. Namely, in this case, the cover layer may be formed without using a TAC film as the cover sheet.

Methods of Recording and Reproducing Information Using Optical Information Recording Medium of the Invention

Next, a method of recording information on the optical information recording medium of the invention and a method of reproducing information from the medium are described.

Information is recorded on the optical information recording medium, for example, as follows.

First, an optical information recording medium is irradiated with a laser beam for recording information from the side at which the cover layer is disposed while rotating the medium at a constant linear speed or a constant angular velocity. By this irradiation, the recording layer absorbs the laser light and the temperature rises locally at the irradiated portion. The rise in temperature causes a physical or chemical change (e.g., formation of pits) to alter the optical properties of the irradiated portion, whereby information is recorded.

As the laser light source having an oscillating wavelength of 450 nm or less (preferably, 380 to 434 nm), for example, a blue-violet semiconductor laser having an oscillating wavelength of 400 to 410 nm, a blue-green semiconductor laser having a central oscillating wavelength of 405 nm, and the like are listed. In order to increase recording density, it is particularly preferable to use a blue-violet semiconductor laser capable of emitting a laser beam of a shorter wavelength. Further, in order to increase recording density, an NA of an objective lens used for pick-up is preferably 0.7 or more, and more preferably 0.85 or more.

The recorded information may be reproduced by irradiating the optical information recording medium with a laser beam from the side at which the cover layer is disposed by rotating the medium at the same constant linear speed as described above to detect a reflected light.

Illustrated above are the examples of the optical information recording medium provided with the recording layer containing the organic compound such as a dye as the recording material, however, the recording layer may contain a phase transition metal. If the recording layer containing the phase transition metal is formed, a dielectric layer made of ZnS—SiO₂ or the like is disposed.

### EXAMPLES

The present invention is explained in more detail by way of examples given below. It should be noted that the invention is not limited to the following examples.

### Example 1

The grooved side of a spirally grooved substrate made of polycarbonate (manufactured by Teijin Ltd., trade name: Pan Light AD5503), which was obtained by injection molding and which had a thickness of 1.1 mm and a diameter of 120 mm and had groove depth of 100 nm, width of 0.120 μm and track pitch of 0.3 μm, was sputtered with Ag under the conditions of a sputtering power of 4.5 kW and an argon flow rate of 20 cm³/sec to form a light-reflective layer having a layer thickness of 150 nm.

Next, ORAZOL BLUE GN (manufactured by Ciba Specialty Chemical Inc.) as a dye was dissolved in 2,2,3,3-tetrafluoropropanol by carrying out an ultrasonic treatment for 2 hours to thereby obtain a dye coating liquid. The dye coating liquid thus prepared was spin-coated on the reflective layer by varying rotational frequency from 300 rpm to 4,000 rpm at 23° C. and 50% RH. Then, the coating layer was kept at 23° C. and 50% RH for 2 hours. Thereafter, a UV-curable adhesive (SD-347 manufactured by Dainippon Ink & Chemicals Inc., an amount of the dissolved dye: 0.05% by mass) was spin-coated at a rotational frequency of 100 to 300 rpm, and the resultant layer was overlaid with a cellulose triacetate (FUJITACK, manufactured by Fuji Photo Film Co., Ltd., thickness: 80 μm) sheet as a cover sheet. The adhesive was then spread over the entire surface by varying rotational frequency from 300 rpm to 4,000 rpm, followed by irradiation with ultraviolet light using a UV lamp to form a cover layer. Thus, an optical information recording medium of Example 1 was produced.

### Example 2

An optical information recording medium of Example 2 was produced in the same manner as in Example 1, except that Ag was changed to Al and Al sputtering was conducted under the conditions of a sputtering power of 3.0 kW and an argon flow rate of 3 cm³/sec to form the light-reflective layer having a layer thickness of 150 nm.

### Example 3

An optical information recording medium of Example 3 was produced in the same manner as in Example 1, except that Ag sputtering was conducted under the conditions of a sputtering power of 0.25 kW and an argon flow rate of 1 cm³/sec to provide the light-reflective layer having a layer thickness of 60 nm.

### Example 4

An optical information recording medium of Example 4 was produced in the same manner as in Example 1, except that Ag sputtering was conducted under the conditions of a sputtering power of 0.25 kW and an argon flow rate of 0.3 cm³/sec to dispose the light-reflective layer having a layer thickness of 240 nm.

### Comparative Example 1

An optical information recording medium of Comparative Example 1 was produced in the same manner as in Example 1, except that Ag was sputtered under the conditions of a sputtering power of 7.5 kW and an argon flow rate of 0.3 cm³/sec to arrange the light-reflective layer having a layer thickness of 275 nm.

### Comparative Example 2

An optical information recording medium of Comparative Example 2 was produced in the same manner as in Example 1, except that Ag was sputtered under the conditions of a sputtering power of 35 kW and an argon flow rate of 36 cm³/sec to form the light-reflective layer having a layer thickness of 150 nm.

Evaluation

The thus produced optical information recording media of Examples 1 to 4 and Comparative Examples 1 to 2 were evaluated for the noise and jitter characteristics. Then, the cover layer was peeled off and the recording layer was removed to conduct AFM measurements at the surface of the light-reflective layer.

Evaluation of Noise

The produced optical information recording media were assessed using an apparatus for evaluating recorded and reproduced information (DDU1000 manufactured by Pulsetech Corp.) equipped with a 405 nm laser and an NA 0.85 pick-up. The apparatus measures the reflectance at a non-recorded area using an oscilloscope at a clock frequency of 66 MHz/(linear speed: 5.6 m/s), and an “amplitude of signal/size of signal” is defined as a noise. It is preferable that the optical information recording media have a noise of 10% or less.

Evaluation of Noise With Time

The optical information recording media as obtained above were stored in an atmosphere of 40° C. and 80% RH for one week and the measurements were carried out in a similar manner to the above-described noise evaluation.

Evaluation of Jitter

The obtained optical information recording media were assessed using an apparatus (DDU1000 manufactured by Pulsetech Corp.) equipped with a 405 nm laser and an NA 0.85 pick-up. 1-7PP modulating signals were recorded and reproduced so as to measure jitter using a time interval analyzer at a clock frequency of 66 MHz/(linear speed: 5.6 m/s). It is preferable that the optical information recording media show a jitter value of 10% or less.

Peeling of Cover Layer and Removal of Recording Layer

After measurements of noise and jitter, the cover layer had an incision made therein to be peeled off from the optical information recording media, and the recording layer was removed using an alcohol-based solvent. After the removal, the AFM measurement was conducted to determine the central surface average roughness SRa and the number of projections having a height from a reference plane of 50 nm or greater. Incidentally, the AFM measurement was conducted 5 minutes after the removal of the recording layer.

Measurement of Central Surface Average Roughness SRa

The optical information recording media were assessed for the central surface average roughness SRa, using SPA500 (manufactured by Seiko Instruments Inc.) under the following measuring conditions.

<Measuring Conditions>

Mode: AFM mode (contact mode)

Measuring probe: SI AF01 (spring constant: 0.1 N/m)

Scanning range: 30 μm angle

Scanning line: 512×512

Scanning speed: 2 Hz

Measurement of Number of Projections Having Height from Reference Plane of 50 nm or Greater

The number of projections was measured using an AFM under the same conditions as those for the central surface average roughness SRa to find the number of projections per 90 μm angle by three view-field measurement of 30 μm angle.

The results of respective measurements are summarized in Table 1. In Table 1, a term “number of projections” refers to the number of projections having a height from a reference plane of 50 nm or greater.

TABLE 1

| | Central Surface | | | | |
|---|---|---|---|---|---|
| | Average | Number of | | | Noise |
| | Roughness | Projections | Jitter | Noise | with |
| | SRa (nm) | (number) | (%) | (%) | Time (%) |
| Example 1 | 26.9 | 27 | 9.4 | 9.1 | 9.7 |
| Example 2 | 17.3 | 13 | 8.6 | 7.6 | 7.8 |
| Example 3 | 0.36 | 0 | 8.0 | 5.2 | 5.5 |
| Example 4 | 26.8 | 28 | 9.5 | 9.6 | 9.9 |
| Comparative | 27.1 | 34 | 10.1 | 10.3 | 12.6 |
| Example 1 | | | | | |
| Comparative | 78.5 | 61 | 11.5 | 20.5 | 27.3 |
| Example 2 | | | | | |

As seen from Table 1, all the optical information recording media of Examples 1 to 4 that have the central surface average roughness SRa of 30 nm or smaller and the number of projections having a height from a reference plane of 50 nm or greater of 30 (number/90 μm angle) or less show a value of 10% or less in both of jitter and noise, revealing that the optical information recording media according to the present invention have excellent characteristics of suppressed noise and low jitter and hence have high reliability.

In contrast, the optical information recording media of Comparative Examples 1 and 2, in which the central surface average roughness SRa and the number of projections having a height from a reference plane of 50 nm or greater are outside the range specified by the invention, have high noise and high jitter.

As detailed above, the present invention can provide an optical information recording medium that is excellent in jitter, noise and the like and has high reliability.

What is claimed is:

1. An optical information recording medium comprising:
a substrate having successively disposed thereon a light-reflective layer, a recording layer and a cover layer,
wherein information can be recorded on and reproduced from the recording layer by irradiating a laser beam from a side at which the cover layer is disposed, and a surface of the light-reflective layer at a side at which the recording layer is disposed has a central surface average roughness SRa of 30 nm or smaller and a number of projections having a height from a reference plane of 50 nm or greater, as determined with an atomic force microscope (AFM), of 30 (number/90 μm angle) or less.

2. The optical information recording medium according to claim 1, wherein the substrate comprises a material selected from the group consisting of an acrylic resin, a vinyl chloride resin, an epoxy resin, an amorphous polyolefin, a polyester and a metal.

3. The optical information recording medium according to claim 1, wherein the substrate comprises at least one of an amorphous polyolefin and a polycarbonate.

4. The optical information recording medium according to claim 3, wherein the substrate has a thickness of 1.1±0.3 mm.

5. The optical information recording medium according to claim 1, wherein the substrate includes a pre-groove having a track pitch of 200 to 400 nm and a groove depth of 20 to 150 nm.

6. The optical information recording medium according to claim 1, wherein an undercoat layer is disposed on a surface of the substrate at a side thereof at which the light-reflective layer is disposed.

7. The optical information recording medium according to claim 6, wherein the undercoat layer has a thickness of 0.005 to 20 μm.

8. The optical information recording medium according to claim 1, wherein the light-reflective layer contains a light-reflective material having a reflectance of 70% or more with respect to a laser beam.

9. The optical information recording medium according to claim 8, wherein the light-reflective material contains at least one element selected from the group consisting of Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi.

10. The optical information recording medium according to claim 8, wherein the light-reflective material is Au, Ag, or an alloy containing Au or Ag as a main component.

11. The optical information recording medium according to claim 8, wherein the light-reflective layer is formed by a method selected from the group consisting of a vapor deposition method, a sputtering method and an ion-plating method.

12. The optical information recording medium according to claim 1, wherein the central surface average roughness SRa is from 0.25 to 10 nm.

13. The optical information recording medium according to claim 1, wherein the central surface average roughness SRa is from 0.25 to 2.5 nm.

14. The optical information recording medium according to claim 1, wherein the number of projections having a height from a reference plane of 50 nm or greater, as determined with an atomic force microscope (AFM), is 15 or less.

15. The optical information recording medium according to claim 1, wherein the number of projections having a height from a reference plane of 50 nm or greater, as determined with an atomic force microscope (AFM), is 5 or less.

16. The optical information recording medium according to claim 8, wherein the light-reflective layer has a thickness of 10 to 250 nm.

17. The optical information recording medium according to claim 1, wherein the recording layer contains at least one of a Ge—Sb—Te alloy and an Ag—In—Sb—Te alloy as a recording material.

18. The optical information recording medium according to claim 1, wherein the recording layer contains a compound selected from the group consisting of triazole, triazine, cyanine, merocyanine, aminobutadiene, phthalocyanine, cinnamic acid, viologen, azo, oxonol, benzoxazole and benztriazole.

19. The optical information recording medium according to claim 1, wherein the recording layer has a thickness of 20 to 500 nm.

20. The optical information recording medium according to claim 19, wherein the recording layer contains a singlet oxygen quencher as an anti-fading agent.
